(19) United States
(12) Patent Application Publication
(10) Pub. No.: US 2011/0303819 A1
(43) Pub. Date: Dec. 15, 2011

(54) DISPLAY STAND WITH WEAR STRUCTURE

(76) Inventor: YI-CHING KUO, Taipei City (TW)

(21) Appl. No.: 13/089,318

(22) Filed: Apr. 19, 2011

(30) Foreign Application Priority Data
Jun. 10, 2010 (TW) 099211036

(51) Int. Cl. F16M 11/20

(52) U.S. Cl. 248/636

(57) ABSTRACT

A display stand comprises at least one connecting block having a through hole for accommodating a supporting pole and at least one recess for pivotably connecting with a sloping pole, wherein an isolating element is disposed between the connecting block and the supporting pole within the through hole. The connecting block defines at least one annular groove in the through hole. The isolating element is provided with an annular rib corresponding to the annular groove to enable the isolating element to be snugly fitted in the through hole of the connecting block. The isolating element has an opening to provide a predetermined elastic fore of deformation.

Accordingly, when the display stand is unfolded or folded, damages of the connecting block and the supporting pole due to friction therebetween can be eliminated via the isolating element so as to maintain the appearance and increase the service life of the stand.

### TECHNICAL FIELD OF THE INVENTION

The present invention relates to a display stand with wear structure and, more particularly, to a display stand that can protect the connecting block and the supporting pole from being damaged due to a friction resulting from a relative movement between the connecting block and the supporting pole when the stand is being unfolded or folded, so as to maintain the appearance of the display stand and increase the service life of the display stand.

### DESCRIPTION OF THE PRIOR ART

A Taiwan Utility Model patent no. 499019, one of the applicant's creations regarding display stands and auxiliary products thereof has disclosed an improved structure of display stand, which is a simple device that can be assembled easily and manufactured inexpensively The patent generally comprises a connecting block, a supporting pole, and a sloping pole, wherein the connecting block defines a through hole to receive the supporting pole and a recess for pivotably connecting the sloping pole so that a foldable display stand can be constructed. Also, the display stand can be extended in horizontal or vertical direction via repetitive use of the aforementioned components. However, when the display stand is being unfolded or folded, due to relative movement or fiction existed between the connecting block and the supporting pole, a damage on the surface of the supporting pole or the through hole of the connecting block may occur. This not only destroys the appearance but also reduces the service life of the device.

### SUMMARY OF THE INVENTION

The primary object of the present invention is to provide a display stand that can protect the connecting block and the supporting pole from being damaged due to a friction resulted from a relative movement between the connecting block and the supporting pole under folding or unfolding operation of the stand.

The display stand comprises at least one connecting block having a through hole for accommodating a supporting pole and at least one recess for pivotably connecting with a sloping pole such that the display stand can be unfolded or folded. In the display stand, an isolating element is disposed between the connecting block and the supporting pole within the through hole.

The connecting block defines at least one annular groove in the through hole. The isolating element is provided with at least one annular rib corresponding to the annular groove, such that the isolating element can be snugly fitted in the through hole of the connecting block. The isolating element has an opening to provide a predetermined elastic fore of deformation. Accordingly, when the display stand is being unfolded or folded to cause a relative movement between the connecting block and the supporting pole, damages of the connecting block and the supporting pole due to friction therebetween can be eliminated via the isolating element so as to maintain the appearance of the stand and increase the service life of the stand.

Other objects, advantages, and novel features of the present invention will become more apparent from the following detailed description when taken in conjunction with the accompanying drawings.

### BRIEF DESCRIPTION OF THE DRAWINGS

FIG. 1 is an exploded view of the present invention.

FIG. 2 is a top view of the present invention, which shows a combination of the connecting block and the isolating element according to the present invention

FIG. 3 is a sectional view taken along A-A in FIG. 2, which shows a combination of the connecting block and the isolating element according to the present invention.

FIG. 4 is an exploded view of the present invention, which shows the connecting block, the supporting pole, and the sloping pole according to the present invention.

FIG. 5 is a 3-dimensional view of the present invention, which shows an unfolded display stand according to the present invention.

FIG. 6 shows a 3-dimensional view and a sectional view of the present invention, illustrating a status of the connecting block and the supporting pole when the display stand is being folded according to the present invention.

FIG. 7 is a partially 3-dimensional view and a sectional view of the present invention, illustrating a status of the connecting block and the supporting pole when the display is being unfolded according to the present invention.

FIG. 8 is a sectional view of the present invention, which shows a combination of the connecting block and the isolating element according to a second embodiment of the present invention.

FIG. 9 is a sectional view of the present invention, which shows a combination of the connecting block and the isolating element according to a third embodiment of the present invention.

FIG. 10 is an exploded view of the present invention, which shows the connecting block and the isolating element according to a fourth embodiment of the present invention.

FIG. 11 is a top view of the present invention, which shows a combination of the connecting block and the isolating element according to a fourth embodiment of the present invention

FIG. 12 is an exploded view of the present invention, which shows the connecting block and the isolating element according to a fifth embodiment of the present invention.

FIG. 13 is a sectional view of the present invention, which shows a combination of the connecting block and the isolating element according to a fifth embodiment of the present invention.

FIG. 14 is an exploded view of the present invention, which shows the connecting block and the joint according to a sixth embodiment of the present invention.

FIG. 15 is a top view of the present invention, which shows a display stand according to a sixth embodiment of the present invention

FIG. 16 is a top view of the present invention, which shows a display stand according to a seven embodiment of the present invention.

FIG. 17 is a top view of the present invention, which show a display stand according to an eighth embodiment of the present invention

### DETAILED DESCRIPTION OF THE PREFERRED EMBODIMENTS

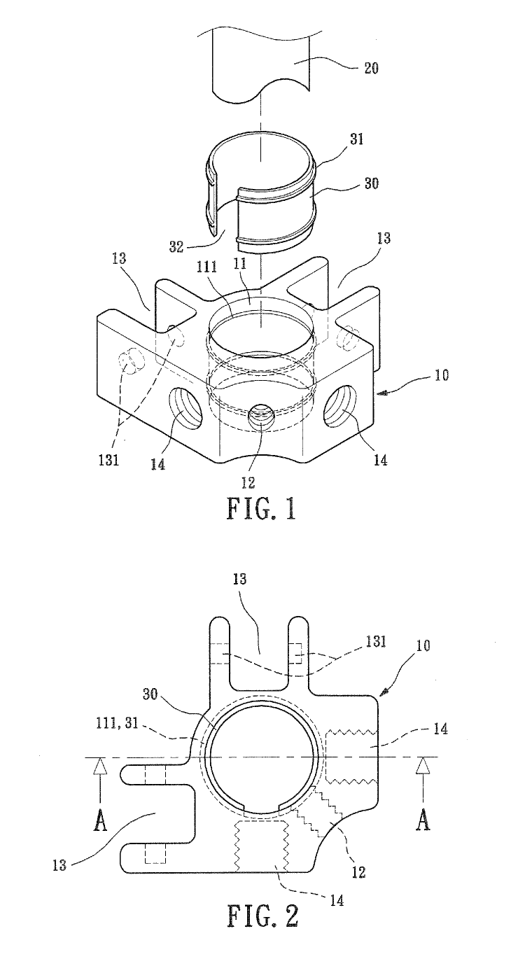

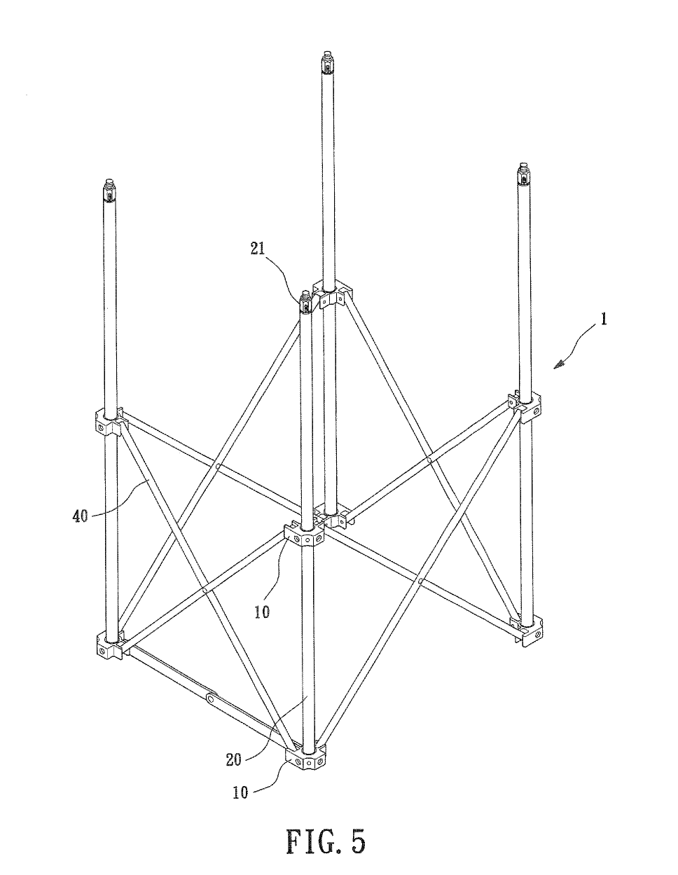

Please refer to FIG. 1 and FIG. 5. A preferred embodiment of the present invention is shown, which generally comprises a connecting block 10, a supporting pole 20, an isolating element 30, and a sloping pole 40. The supporting pole 20 can be insertedly fixed to the connecting block 10. The isolating element 30 is disposed in the connecting block 10 to accommodate the supporting pole 20. The user can employ a plurality of connecting block 10 with an isolating element 30, a plurality of supporting pole 20, and a plurality of sloping pole 40 to construct a foldable display stand 1 with wear structure.

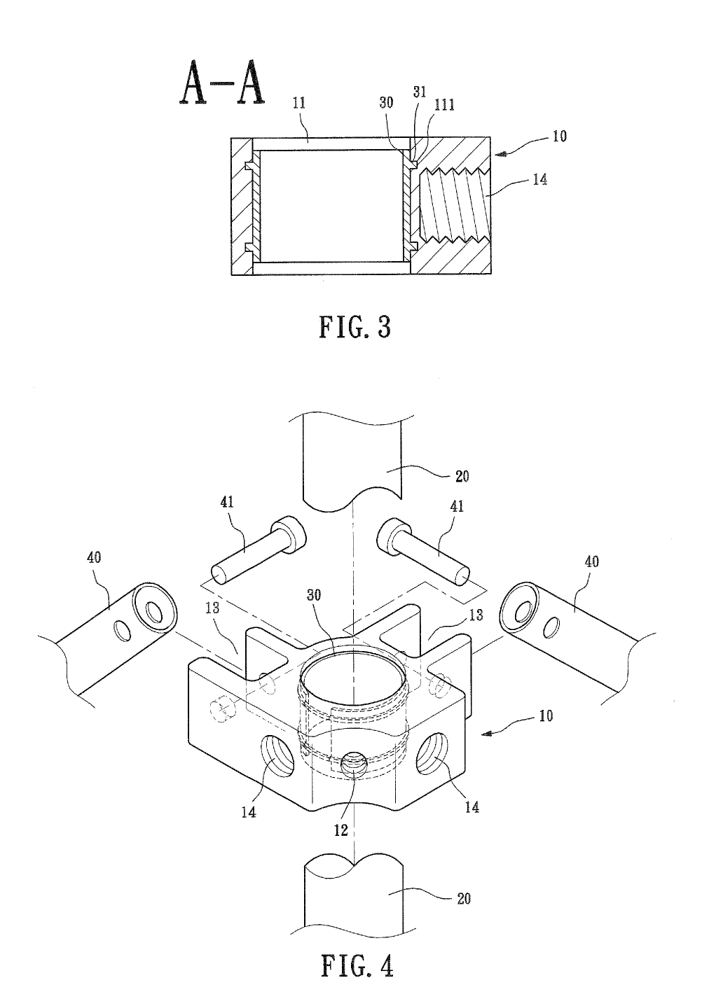

Please refer to FIGS. 1-4. As shown, the connecting block 10 defines a through hole 11 to receive the supporting pole 20. Two annular grooves 111 are defined in the through hole 11. The connecting block 10 is provided with a hole 12 for fastening the supporting pole 20. If the hole 12 is not fitted with a fastening element, such as a screw, the connecting block 10 and the supporting pole 20 can have a relative movement to each other. In other words, the connecting block 10 can move forth or back along the supporting pole 20. In FIG. 5, the connecting block 10 and the supporting pole 20 in the middle section of the display stand 1 are both in a movable condition, which allows the stand to unfold or fold. If the hole 12 is fitted with a fastening element, such as a screw, the connecting block 10 and the supporting pole 20 can be fixed together so that the connecting block 10 cannot have a relative movement to the supporting pole 20. In FIG. 5, the connecting block 10 and the supporting pole 20 in the bottom section of the stand are both in a fixed condition and thus constitute a foundation for the stand. The connecting block 10 is provided with two recesses 13, each provided with two pivot holes 131 for pivotably connecting with the sloping pole 40 via a pin 41. The connecting block 10 is further provided with two threaded holes 14 for engagement with another supporting pole 20 so that the display stand 1 can be extended in horizontal direction.

The isolating element 30, being substantially a hollow cylinder, has a shape substantially conforming to the through hole 11. The isolating element 30 has two annular ribs 31, corresponding to the annular grooves 111, formed on an outer surface thereof. The isolating element 30 is disposed within the through hole 11 such that the annular ribs 31 can be snugly fitted in the annular grooves 111 so that the isolating element 30 is affixed to the connecting block 10, whereby the isolating element 30 can act as an intermediary component between the connecting block 10 and the supporting pole 20 to prevent them from direct contact. The isolating element 30 can be formed of elastic material, such as plastic. The isolating element 30 can be provided with an opening 32 to have it with a predetermined force of deformation, whereby the isolating element 30 can be compressed to be received in the through hole 11 more easily. Thereafter, the isolating element 30 can be snugly fitted in the through hole 11 since the isolating element 30 can exert an outwardly elastic force to the connecting block 10.

Please refer to FIG. 5. As shown, the display stand 1 of the present invention, being under an unfolded condition, comprises a plurality of connecting blocks 10, a plurality of supporting poles 20, and a plurality of sloping poles 40. The supporting pole 20 is further provided with a rotatable connector 21 such that one supporting pole 20 can be connected with another supporting pole 20, via the rotatable connector 21, to enable the display stand to extend in vertical direction. Alternatively, the rotatable connector 21 of the supporting pole 20 can be threadedly fitted in the threaded hole 14 of a connecting block 10 to enable the display stand 1 to extend in horizontal direction.

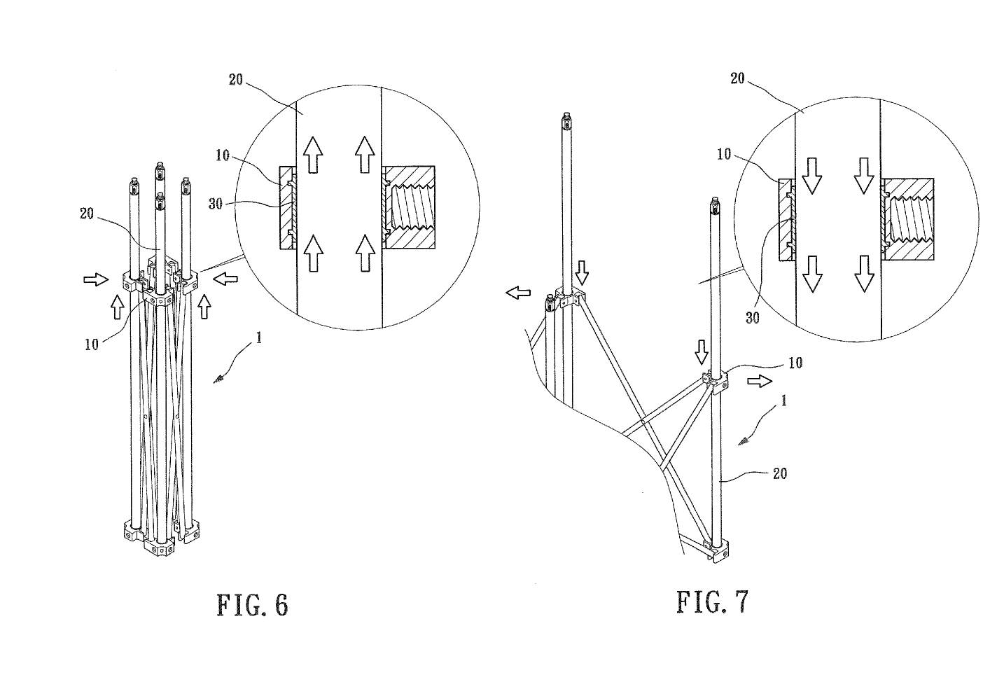

Please refer to FIGS. 5-7. As shown, the isolating element 30 of the present invention is disposed between the connecting block 10 and the supporting pole 20. When the display stand 1 is being unfolded or folded, the connecting block 10 in the middle section of the supporting pole 10 can be moved relative to the supporting pole 20. In other words, the connecting block 10 can be moved forth or back along the supporting pole 20. Therefore, the isolating element 30 can act as an intermediary component to prevent the connecting block 10 and the supporting pole 20 from direct contact, such that the connecting block 10 and the supporting pole 20 can be protected from being damaged due to a friction resulted from a relative movement between the connecting block 10 and the supporting pole 20, such that the appearance of the stand can be maintained and the service life of the stand can be increased.

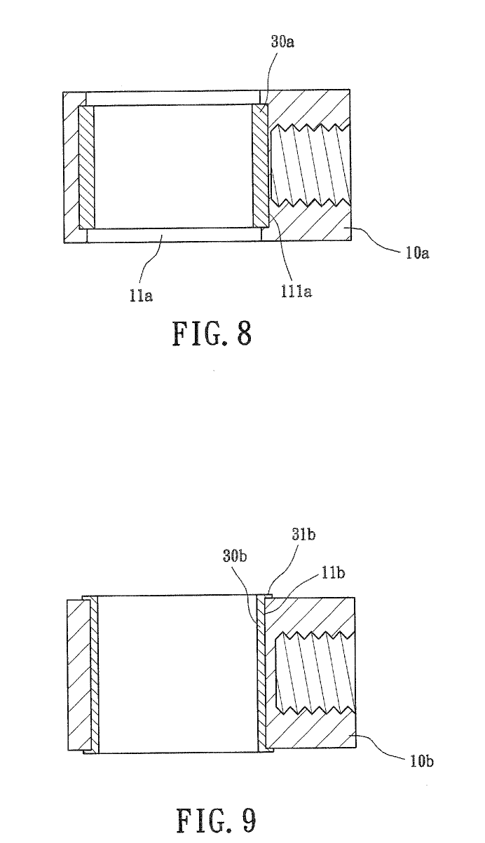

Referring to FIG. 8, a second embodiment of the present invention is disclosed. As shown, the isolating element 30a is formed without the annular ribs as provided in the aforementioned embodiment. The isolating element 30a has a diameter greater than the through hole 11a of the connecting block 10a. The connecting block 10a defines an annular recess 111a, which has a shape corresponding to the isolating element 30a, in the through hole 11a to enable the isolating element 30a to be snugly fitted in the annular recess 111a, such that the isolating element 30a can be affixed to the connecting block 10a.

Referring to FIG. 9, a third embodiment of the present invention is disclosed. As shown, the isolating element 30b is provided with two flanges 31b respectively at two end thereof to engage with two exits of the through hole 11b, such that the isolating element 30b can be affixed to the connecting block 10b.

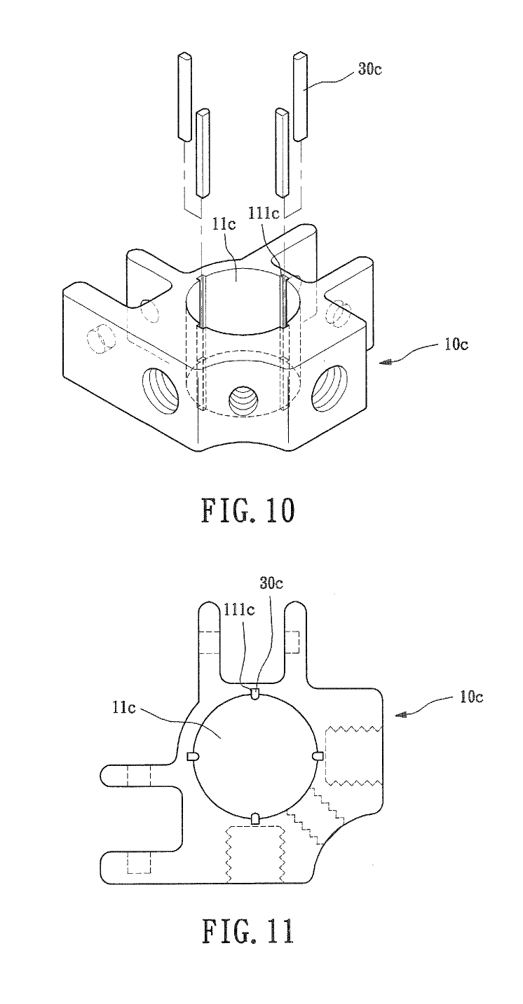

Referring to FIG. 10 and FIG. 11, a fourth embodiment of the present invention is disclosed. As shown, the isolating element includes a plurality of elongated strip 30c. The connecting block 10c defines a plurality of elongated slot 111c, corresponding to the elongated strips 30c, in the through hole 11c such that the elongated strips 30c can be snugly fitted in the elongated slot 111c such that the isolating element can be affixed to the connecting block 10c.

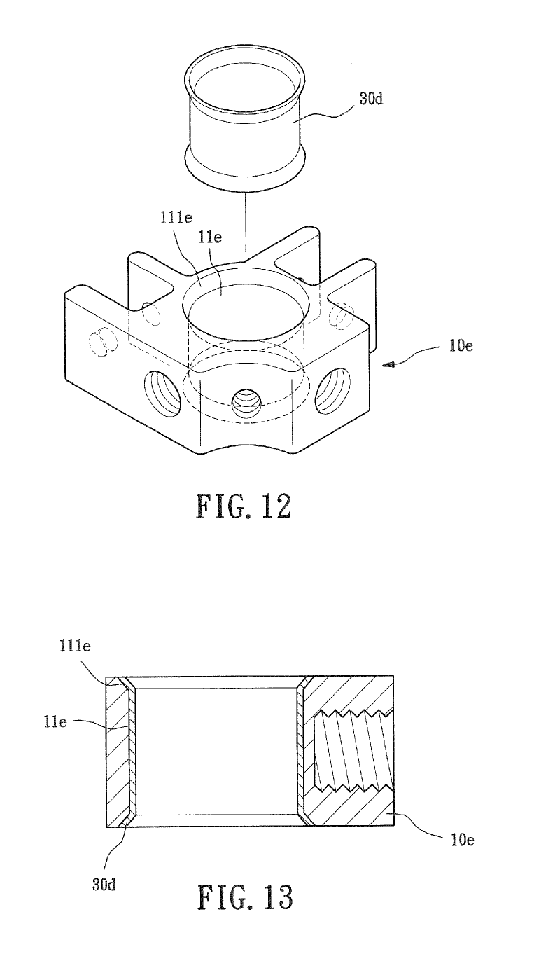

Referring to FIG. 12 and FIG. 13, a fifth embodiment of the present invention is disclosed. As shown, the isolating element 30d has two conical flanges respectively on two ends thereof. The connecting block 10e defines two countersinks 111e respectively at two exits thereof, corresponding to the conical flanges, in the through hole 11e such that the conical flanges can be snugly fitted in the countersinks such that the isolating element 30d can be affixed to the connecting block 10e.

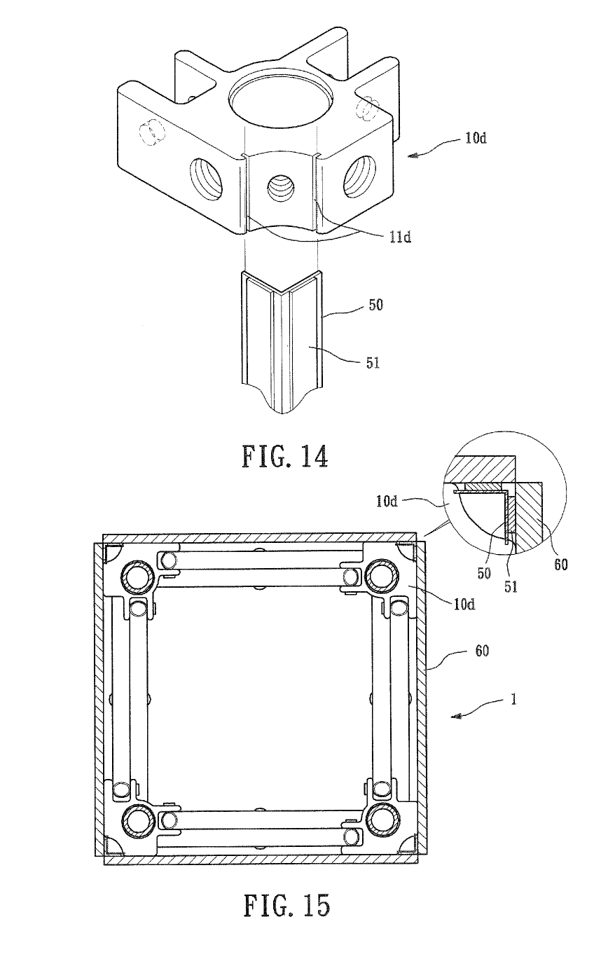

Referring to FIG. 14 and FIG. 15, a sixth embodiment of the present invention is disclosed. As shown, the connecting block 10d defines two elongated slot lid for mounting a joint 50 having an L-shaped cross section. The joint 50 is provided with two panel-attaching portions 51 respectively on two sides thereof. Each panel-attaching portion 51 can be formed with a magnetic or adhesive element so as to attract or stick a flat panel or screen 60. Therefore, the display stand 1 can be mounted with 4 pieces of panels at four sides thereof such that the stand appears as a square column.

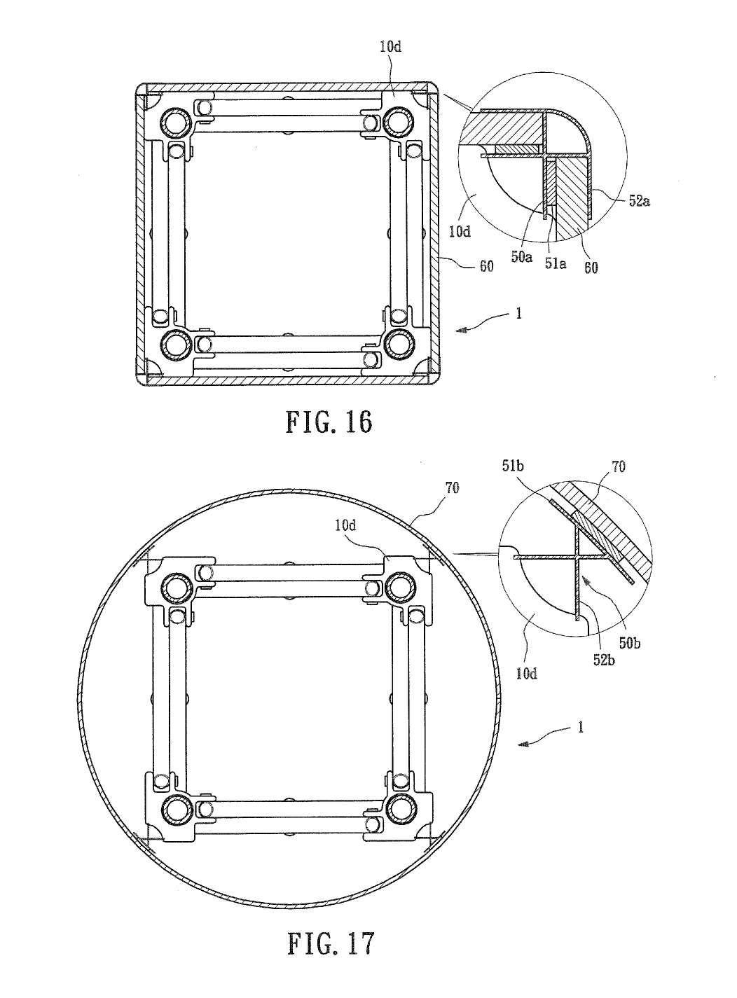

Referring to FIG. 16, a seventh embodiment of the present invention is disclosed As shown, the joint 50a is further provided with two recesses 52a respectively on two sides thereof in corporation with a respective panel-attaching portion 51a to be each snugly fitted with a panel or screen 60, such that the panel or screen 60 can be securely fixed.

Referring to FIG. 17, an eighth embodiment of the present invention is disclosed. As shown, the joint 50b, being substantially shaped as a crossed component with a plate and being mounted to the connecting block 10d, is provided with one panel-attaching portion on the plate, opposite to the connecting block 10d, for attracting or sticking a cylindrical panel or screen 70, such that the display stand 1 can be constructed as a circular column.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A display stand comprising a connecting block, which defines a through hole for accommodating a supporting pole and a recess for pivotably connecting a sloping pole, to construct a foldable stand, the display stand characterized in that:
an isolating element being disposed between said connecting block and said supporting pole, said connecting block defining an annular groove in said through hole, said isolating element having an annular rib corresponding to said annular groove in said through hole to enable said isolating element to be affixed to said connecting block, said isolating element having an opening to provide a predetermined elastic force of deformation; whereby, under folding or unfolding operation of the stand, said connecting block and said supporting pole can be prevented from being damaged due to a friction resulted from a relative movement between said connecting block and said supporting pole.

2. The display stand of claim 1, wherein two conical flanges are respectively formed at two ends of said isolating element instead of said annular rib, said connecting block has two countersinks corresponding to said conical flanges, such that the isolating element can be affixed to said connecting block via engagement of said conical flanges and said countersinks.

3. The display stand of claim 1, wherein said connecting block is provided with an elongated slot for mounting a joint, which includes a panel-attaching portion for mounting a panel or screen.

4. The display stand of claim 3, wherein said joint defines a recess, in cooperation with said panel-attaching portion, for mounting a screen or panel therein.

5. The display stand of claim 3, wherein said panel-attaching portion of said joint is formed with a magnetic or adhesive element.
